(19) United States
(12) Patent Application Publication
(10) Pub. No.: US 2023/0080561 A1
(43) Pub. Date: Mar. 16, 2023

(54) TRANSPARENT PHOSPHOR AND LIGHT SOURCE DEVICE

(71) Applicant: TDK CORPORATION, Tokyo (JP)

(72) Inventor: Tatsuya TERUI, Tokyo (JP)

(73) Assignee: TDK CORPORATION, Tokyo (JP)

(21) Appl. No.: 17/873,744

(22) Filed: Jul. 26, 2022

(30) Foreign Application Priority Data
Aug. 25, 2021 (JP) 2021-137375

(51) Int. Cl. F21V 9/30

(52) U.S. Cl. CPC F21V 9/30

(57) ABSTRACT

Provided is a transparent phosphor in which one surface is rougher than the other surface.

### BACKGROUND OF THE INVENTION

### 1. Field of the Invention

The present invention relates to a transparent phosphor and a light source device using the transparent phosphor.

### 2. Description of the Related Art

The phosphor is widely used as a color tone conversion material for illumination or a projector using an LED or a laser, or the like. For example, JP 6371201 B2 discloses a transparent phosphor in which impurities such as pores and grain boundaries which become the cause for scattering of light hardly exist.

The transparent phosphor has a dense structure, and thus a heat dissipation property and heat resistance are more excellent in comparison to a non-transparent phosphor such as powder fluorescent bodies and non-transparent ceramics. Accordingly, even when using an excitation light source such as a laser with a high energy density, a stable quantity of light can be obtained. On the other hand, a problem of “inner surface waveguide” in which fluorescence is confined at the inside of the phosphor due to total reflection of the fluorescence at the inside of the phosphor appears prominently in the transparent phosphor in comparison to the non-transparent phosphor.

When the inner surface waveguide occurs, a light-emitting spot diameter of the fluorescence becomes large. When the light-emitting spot diameter becomes large, a large optical member is required to condense generated fluorescence, and thus there is a concern that a device becomes large, or in a case where condensing is difficult, a problem such thing as light-emitted luminous flux of a device decreases in accordance with an increase in etendue.

### SUMMARY OF THE INVENTION

An object of the present invention is to provide a transparent phosphor capable of narrowing a light-emitting spot diameter of fluorescence.

To solve the problem, a transparent phosphor according to the present invention comprising a pair of surfaces.

One surface is rougher than the other surface.

The present inventors found that when the transparent phosphor has the above-described configuration, a light-emitting spot diameter of fluorescence can be narrowed. In the present invention, one surface of the transparent phosphor is rougher than the other surface. Accordingly, it is considered that surface scattering of excitation light can be increased on one rougher surface. As a result, the scattered excitation light is wavelength-converted in the vicinity of an irradiation position, and is efficiently mixed with fluorescence that is isotropically emitted from the same position. Accordingly, it is considered that white light in which the light-emitting spot diameter is small, and color unevenness such as a yellow ring is less can be obtained. Note that, the yellow ring represents a phenomenon in which only a fluorescent component is leaked from a surface of a phosphor on an outer side of the light-emitting spot, and thus color unevenness in which the periphery of projection light (white) becomes yellow occurs.

In addition, since the one surface is rough, light reflected from the other surface is likely to be emitted to the outside of the transparent phosphor from the one surface. Accordingly, light can be emitted from the one surface to the outside of the transparent phosphor in a small number of times of reflection about one time. Accordingly, it is considered that inner surface waveguide can be reduced.

From the reasons, according to the transparent phosphor according to the present invention, the inner surface waveguide can be reduced, and thus it is considered that the light-emitting spot diameter of fluorescence can be narrowed, and a reduction in size of a device and an improvement of light usage efficiency can be realized. The transparent phosphor can be preferably used for a projector light source, or a light source of a spotlight, a projector, a headlight, and the like.

In addition, when only a fluorescent component is leaked from a surface of the phosphor on an outer side of the light-emitting spot diameter due to the inner surface waveguide, there is a problem that the yellow ring occurs. However, according to the present invention, the inner surface waveguide can be suppressed, and thus occurrence of the yellow ring can be prevented.

Furthermore, according to the present invention, since the inner surface waveguide can be suppressed, extraction efficiency of fluorescence can be improved.

Furthermore, in the present invention, since the other surface is relatively smooth, reflection efficiency of the other surface is high. Accordingly, leakage of light from the other surface can be prevented, and thus extraction efficiency of light on the one surface side can be raised, and luminance can be raised.

Furthermore, since leakage of excitation light from the other surface can be prevented, a deterioration of a structure disposed on an outer side of the other surface of the transparent phosphor due to the excitation light can be suppressed.

Furthermore, when the other surface is set to be smooth, deposition of a reflective film or the like on the other surface can be performed with accuracy, and thus reflection efficiency can be raised.

The pair of surfaces may face each other.

Preferably, arithmetic average roughness (IRa) of the one surface is 0.80 μm or greater.

Preferably, arithmetic average roughness (RRa) of the other surface is 0.30 μm or less.

In the transparent phosphor according to the present invention, a transmittance of light having a wavelength of 540 nm may be 70% or greater.

When the transmittance of light having a wavelength of 540 nm may be 70% or greater, thermal conductivity becomes high, and as a result, an influence of thermal quenching can be suppressed.

Preferably, a composition of a main component of the transparent phosphor is AₓB_{y}O_{z},

x is 2.7 to 3.3,

y is 4.7 to 5.3,

z is 11.7 to 12.3,

A is at least one kind selected from the group consisting of Y, Gd, Tb, Yb, and Lu,

B is at least one kind selected from the group consisting of Al, Ga, and Sc, and

an activating agent is at least one kind selected from the group consisting of lanthanoid elements and actinide elements.

When the composition of the main component of the transparent phosphor is within the above-described range, a transparent phosphor having a fluorescent property is likely to be obtained.

Preferably, A comprises Y, and B comprises Al,

the activating agent is at least one kind selected from the group consisting of Ce, Nd, and Gd, and

the amount of the activating agent is 0.7 to 2.5 parts by mol, when the amount of Y is set as 100 parts by mol.

When the composition of the main component of the transparent phosphor is within the above-described range, white light is easily obtained by combining fluorescence by the transparent phosphor and excitation light. In addition, when the amount of the activating agent is within the above-described range, high conversion efficiency can be accomplished.

The one surface may be an incident surface of excitation light, and the other surface may be a reflective surface of the excitation light.

The incident surface may also be an emission surface of the excitation light.

According to this, the reflective surface side can be effectively used for heat dissipation, and thus there is an advantage that high luminance is likely to be obtained.

Preferably, the transparent phosphor includes a reflective film on the reflective surface.

Reflection efficiency of light on the reflective surface of the transparent phosphor can be raised due to the reflective film. According to this, leakage of light from the reflective surface can be further prevented, and thus the light extraction efficiency on the incident surface (emission surface) side can be further raised, and the luminance can be further raised. In addition, since leakage of the excitation light from the reflective surface can be further prevented, a deterioration of the structure disposed on an outer side of the reflective surface of the transparent phosphor due to the excitation light can be further suppressed.

Preferably, the transparent phosphor includes a reflective film on a surface other than the incident surface.

According to this, leakage of light from a surface other than the incident surface (emission surface) can be prevented, and thus extraction efficiency of light can be further raised, and the luminance can be further raised.

Preferably, the thickness of the reflective film is 3 μm or greater, and the reflective film contains an oxide of at least one kind selected from the group consisting of Si, Ti, and Al.

Preferably, the transparent phosphor includes an excitation light control film on the incident surface,

the excitation light control film allows incident excitation light to be transmitted therethrough, and reflects again reflected excitation light transmitted from the transparent phosphor, and

the thickness of the excitation light control film is 0.3 μm or greater.

According to this, emission of the reflected excitation light from the incident surface (emission surface) of the transparent phosphor can be prevented, and illumination with high stability can be realized.

In addition, due to an excitation light control film 10, blue light LB can be allowed to remain inside the transparent phosphor 4 until the blue light LB can be sufficiently converted, and thus conversion efficiency to the fluorescence can be raised.

A light source device according to the present invention includes the transparent phosphor, and a blue light-emitting element.

The blue light-emitting element is at least one selected from a blue light-emitting diode and a blue semiconductor laser.

### BRIEF DESCRIPTION OF THE DRAWINGS

FIG. 1 is a schematic cross-sectional view of a light source device according to an embodiment of the present invention;

FIG. 2 is an enlarged view of Part II illustrated in FIG. 1;

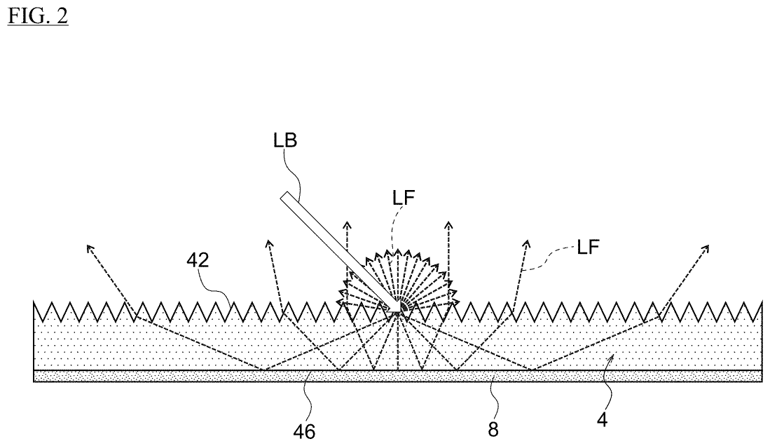

FIG. 3 is a schematic view illustrating an example in the related art;

FIG. 4 is a schematic cross-sectional view of a light source device according to another embodiment of the present invention;

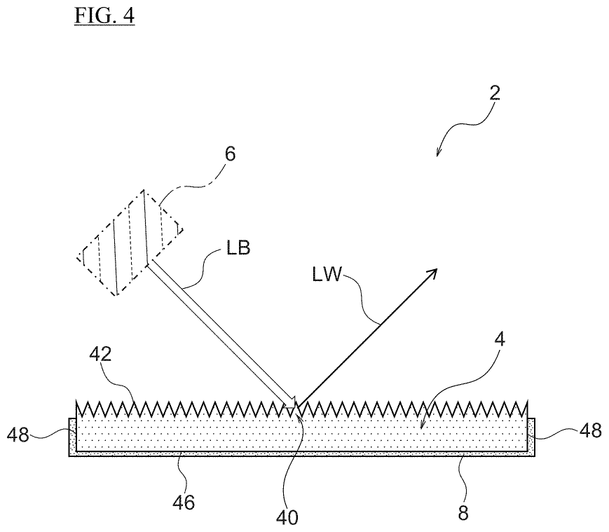

FIG. 5 is a schematic cross-sectional view of a light source device according to still another embodiment of the present invention;

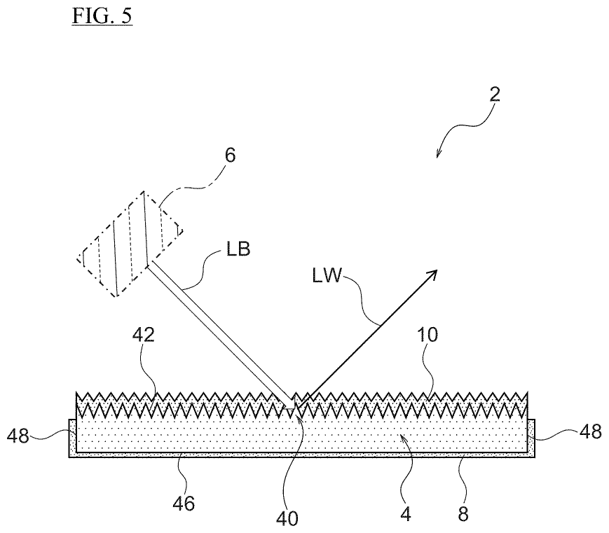

FIG. 6 is a schematic view of a device that measures a full width at half maximum of light-emitting spot diameter;

FIG. 7 is a light-emitting spot photograph of fluorescence according to an example of the present invention; and

FIG. 8 is a graph for obtaining a full width at half maximum of a light-emitting spot diameter according to an example of the present invention.

### DETAILED DESCRIPTION OF THE PREFERRED EMBODIMENTS

### First Embodiment

<Light Source Device>

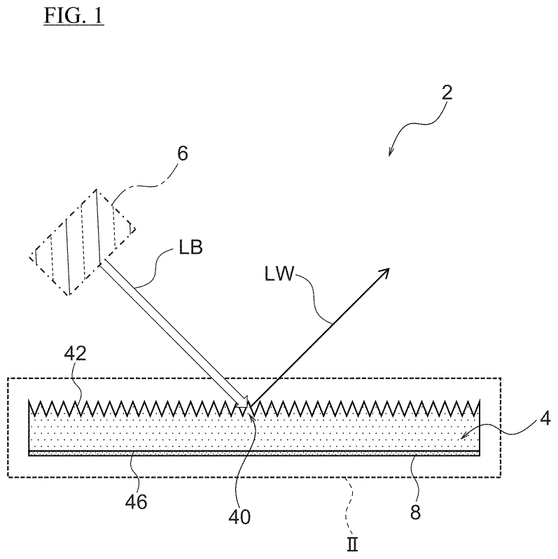

As illustrated in FIG. 1, a light source device 2 according to this embodiment includes a transparent phosphor 4 and a blue light-emitting element 6.

<Blue Light-Emitting Element>

As illustrated in FIG. 1, the blue light-emitting element 6 emits blue light LB that is excitation light for exciting a fluorescent component of the transparent phosphor 4. In the blue light LB of the blue light-emitting element 6, a typical peak wavelength is 425 to 500 nm. A part of the blue light LB incident to the inside from an incident surface 42 of the transparent phosphor 4 is absorbed to the transparent phosphor 4, is wavelength-converted, and emits fluorescence.

Note that, the incident surface 42 of the transparent phosphor 4 is a surface of the transparent phosphor 4 on the blue light-emitting element 6 side. In addition, a reflective surface 46 of the transparent phosphor 4 is a surface of the transparent phosphor 4 on a side opposite to the blue light-emitting element 6 side, and is a surface facing the incident surface 42. That is, the incident surface 42 and the reflective surface 46 are substantially parallel to each other. Note that, “substantially parallel” represents that a portion that is not slightly parallel may be included.

The light source device 2 according to this embodiment is a reflection type, and thus the incident surface 42 is also an emission surface. In the reflection type light source device 2, since the reflective surface 46 side can be effectively used for heat dissipation, there is an advantage that high luminance is likely to be obtained.

The fluorescence LF emitted toward an outer side of the transparent phosphor 4 from the incident surface 42 (emission surface) and the blue light LB are mixed to emit white light LW.

As the blue light-emitting element 6, there is no particular limitation as long as the white light LW can be emitted through mixing with the fluorescence LF, and the blue light LB that can be wavelength-converted into the fluorescence LF by the transparent phosphor 4, can be emitted, and examples thereof includes a blue light emitting diode (blue LED) and a blue semiconductor laser (blue LD).

<Transparent Phosphor>

A shape of the transparent phosphor 4 according to this embodiment is not particularly limited, and examples thereof include a flat plate shape, a disc shape, and a rectangular parallelepiped column shape, and a pair of surfaces facing each other are provided.

In this embodiment, the incident surface 42 and the reflective surface 46 face each other, and surface roughness of the incident surface 42 is greater than surface roughness of the reflective surface 46.

A component of the transparent phosphor 4 according to this embodiment is not particularly limited, and a composition of a main component is AₓB_{y}O_{z}. Here, x is 2.7 to 3.3, y is 4.7 to 5.3, and z is 11.7 to 12.3. Here, the “main component” represents a component that does not contain an activating agent to be described later.

In addition, A is preferably at least one kind selected from the group consisting of Y, Gd, Tb, Yb, and Lu, and more preferably Y.

B is preferably at least one kind selected from the group consisting of Al, Ga, and Sc, and more preferably Al.

The activating agent of the transparent phosphor 4 according to this embodiment is preferably at least one kind selected from lanthanoid elements and actinide elements, and more preferably at least one kind selected from Ce, Nd, and Gd.

When the amount of A is set as 100 parts by mol, the amount of the activating agent is preferably 0.7 to 2.5 parts by mol.

Ce:YAG, Ce:LuAg, and Ce:GAGG constituting the transparent phosphor 4 have the same garnet composition, and have refractive indexes which are extremely close to each other. Specifically, a refractive index of Ce:YAG is 1.82, a refractive index of Ce:LuAg is 1.84, and a refractive index of Ce:GAGG is 1.90. Accordingly, in a case of using Ce:YAG, Ce:LuAg, or Ce:GAGG as a material of the transparent phosphor 4 according to this embodiment, it is considered that the same behavior is exhibited and the same effect is obtained.

Note that, concentrations of respective components of the transparent phosphor 4 can be measured by laser ablation ICP mass analysis (LA-ICP-MS), electron probe microanalyzer (EPMA), energy dispersive spectrometer (EDX), or the like.

When arithmetic average roughness of the incident surface 42 is set as “IRa” and arithmetic average roughness of the reflective surface 46 is set as “RRa”, “IRa/RRa” is preferably 2.7 to 6.7.

The arithmetic average roughness (IRa) of the incident surface 42 of the transparent phosphor 4 according to this embodiment is preferably 0.80 μm or greater, more preferably 0.85 μm or greater, and still more preferably 0.88 to 2.00 μm.

The arithmetic average roughness (RRa) of the reflective surface 46 of the transparent phosphor 4 according to this embodiment is preferably 0.30 μm or less, and more preferably 0.26 μm or less.

A crystal state of the transparent phosphor 4 according to this embodiment is not particularly limited, and may be a single crystal or a polycrystal. However, according to this embodiment, when the surface roughness of the incident surface 42 increases, inner surface waveguide can be suppressed, and thus the more the transparent phosphor 4 is transparent, the more an effect of narrowing a light-emitting spot diameter is likely to be obtained through suppression of the inner surface waveguide. Accordingly, the transparent phosphor 4 according to this embodiment is preferably a single crystal.

In addition, as described above, as a light transmittance of the transparent phosphor 4 is higher, the effect of this embodiment can be obtained, and thus a transmittance of light having a wavelength of 540 nm is preferably 70% or greater, and more preferably 75% or greater. In addition, when the transmittance of the light having a wavelength of 540 nm is high, thermal conductivity becomes high, and as a result, an influence of thermal quenching can be suppressed.

The light transmittance of the transparent phosphor 4 contributes, for example, to a component, a composition, and a structure of the transparent phosphor 4. The structure that contributes to the light transmittance of the transparent phosphor 4 is, for example, a structure relating to denseness, and in a dense structure that does not include a void, a grain boundary, and the like, the light transmittance tends to increase.

<Reflective Film>

The transparent phosphor 4 according to this embodiment includes a reflective film 8 on the reflective surface 46.

The thickness of the reflective film 8 according to this embodiment is not particularly limited, but the thickness is preferably 3 μm or greater, and more preferably 20 to 100 μm.

A component of the reflective film 8 according to this embodiment is not particularly limited, but examples of the component include at least one kind of oxide selected from the group consisting of Si, Ti, and Al.

<Method of Manufacturing Transparent Phosphor>

A method of manufacturing the transparent phosphor 4 according to this embodiment is not particularly limited, but examples thereof include the following methods.

First, a typical transparent substance having no characteristic in surface roughness is prepared. A method of manufacturing the transparent phosphor is not particularly limited, and examples thereof include a Czochralski method, a Bridgeman method, a micro pull-down method, an EFG method, and the like.

Ingot processing and slice processing are performed with respect to the obtained transparent phosphor as necessary.

Here, “ingot processing” is processing for forming a circular columnar ingot having a crystal plane orientation according to substrate specifications from an ingot after growth. In addition, “slice processing” is processing for cutting out a circular substrate from the transparent phosphor that has undergone the ingot processing.

Next, rough polishing or mirror polishing is performed with respect to the transparent phosphor as necessary.

“Rough polishing” is processing for removing unevenness (crushed layer) on a surface of the substrate which occurred at the time of slice processing by using free abrasive grains such as diamond slurry. In addition, “mirror polishing” is processing for removing minute unevenness or the like by using colloidal silica or the like with respect to the transparent phosphor that has undergone the rough polishing.

With respect to the obtained transparent phosphor 4, a surface that becomes the incident surface 42 is polished with a polishing cloth. The surface roughness is adjusted by changing an abrasive grain number of the polishing cloth.

Note that, the surface that becomes the reflective surface 46 may be polished with the polishing cloth. In this case, the surface is polished by a polishing cloth with finer particles in comparison to the polishing cloth that is used to polish the incident surface 42.

The reflective film 8 is formed on the reflective surface 46 of the transparent phosphor 4 after being polished. A method of forming the reflective film 8 is not particularly limited, and examples thereof include a vacuum deposition method, a sputtering method, a pulse laser deposition method (PLD method), a metal-organic chemical vapor deposition method (MO-CVD method), a metal-organic decomposition method (MOD method), a sol-gel method, a chemical solution deposition method (CSD method), and the like.

The transparent phosphor 4 according to this embodiment can be obtained by the manufacturing method.

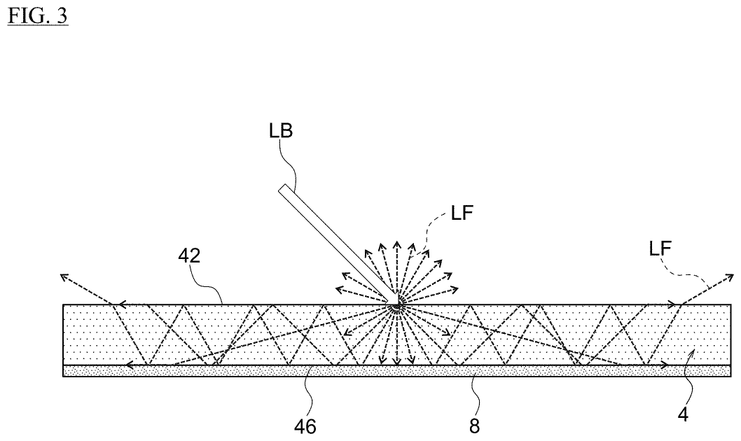

Since the incident surface 42 of the transparent phosphor 4 in the related art is smooth, as illustrated in FIG. 3, the fluorescence LF is isotropically emitted in all directions from an irradiation position of the blue light LB as a starting point. In addition, although not illustrated in the drawing, a part of the blue light LB that is not wavelength-converted, causes surface scattering to occur at the irradiation position of the blue light LB, and the blue light LB is isotropically emitted to all direction from the irradiation position of the blue light LB as a starting point.

As illustrated in FIG. 3, the fluorescence LF emitted to the transparent phosphor 4 side due to Lambertian light distribution is undergone inner surface waveguide in which total reflection is repeated on the reflective surface 46 and the incident surface 42, and the fluorescence LF may be emitted from the incident surface 42 (emission surface) toward the outside of the transparent phosphor 4 at a position spaced apart from the irradiation position.

When the fluorescence LF is emitted from the position spaced apart from the irradiation position, the light-emitting spot diameter may be enlarged, color unevenness called a yellow ring may occur, or luminance may decrease.

Furthermore, since the transparent phosphor 4 in the related art has the smooth surface, in a case where a refraction angle is near 90°, it is difficult to extract the fluorescence LF from the transparent phosphor 4. Particularly, typically, in light with a large reflection angle, an incident angle to the incident surface 42 (emission surface) is also large, and the incident angle is likely to be larger than a threshold angle, and it is difficult to extract the fluorescence LF.

In contrast, in this embodiment, since surface roughness of the incident surface 42 is larger than surface roughness of the reflective surface 46, a part of the blue light LB emitted to the transparent phosphor 4 is effectively scattered in the vicinity of the irradiation position 40 of the incident surface 42. The scattered blue light LB is wavelength-converted in the vicinity of the irradiation position 40, and is effectively mixed with the fluorescence LF that is isotropically emitted from the same position, and thus it is possible to obtain white light LW in which color unevenness such as the yellow ring is less.

In addition, in this embodiment, after being reflected from the reflective surface 46, light may be emitted to the outside of the transparent phosphor 4 from the incident surface 42 (emission surface). The reason for this is because the surface of the incident surface 42 (emission surface) is rough, and thus even when the refraction angle becomes near 90°, light may be emitted from the incident surface 42 (emission surface) of the transparent phosphor 4 to the outside. Accordingly, in this embodiment, the transmitted light can be emitted from the incident surface 42 (emission surface) toward the outside of the transparent phosphor 4 in a small number of times of reflection about one time.

As described above, in this embodiment, since the incident surface 42 is rough, light can be scattered with the incident surface 42, and can be emitted from the incident surface 42 (emission surface) toward the outside of the transparent phosphor 4 with a small number of times of reflection, the inner surface waveguide can be suppressed. As a result, the light-emitting spot diameter of the fluorescence can be narrowed, the yellow ring can be suppressed, and the luminance can be raised.

Furthermore, in this embodiment, since the surface roughness of the incident surface 42 (emission surface) is large, when the fluorescence LF reflected from the reflective surface 46 is incident to incident surface 42, an incident angle to the incident surface 42 (emission surface) can be made smaller in comparison to a case of a smooth surface. Accordingly, the incident angle becomes smaller than the threshold angle, and thus the light extraction efficiency can be raised and the luminance can be raised.

Furthermore, in this embodiment, since the reflective surface 46 is relatively smooth, reflection efficiency of the reflective surface 46 is high. Accordingly, since leakage of light from the reflective surface 46 side can be prevented, the light extraction efficiency from the incident surface 42 can be raised, and the luminance can be raised.

Furthermore, since leakage of the blue light LB from the reflective surface 46 can be prevented, deterioration of a structure disposed on an outer side of the reflective surface 46 of the transparent phosphor 4 due to the blue light LB can be suppressed.

Furthermore, since the reflective surface 46 is made smooth, deposition of the reflective film 8 onto the reflective surface 46 can be performed with accuracy, and thus reflection efficiency can be raised.

In addition, according to this embodiment, reflection efficiency of the blue light LB on the reflective surface 46 of the transparent phosphor 4 can be raised due to the reflective film 8. According to this, since leakage of light from the reflective surface 46 can be prevented, the light extraction efficiency from the incident surface 42 (emission surface) side is higher, and thus the luminance can be raised. In addition, since leakage of the blue light LB from the reflective surface 46 can be further prevented, deterioration of the structure disposed on an outer side of the reflective surface 46 of the transparent phosphor 4 due to the blue light LB can be further suppressed.

### Second Embodiment

A transparent phosphor 4 according to this embodiment is similar to the transparent phosphor 4 of the first embodiment except for the following configuration. The transparent phosphor 4 according to this embodiment includes the reflective film 8 on a surface other than the incident surface 42. Specifically, the transparent phosphor 4 according to this embodiment includes the reflective film 8 on a side surface 48 substantially orthogonal to the reflective surface 46 and the incident surface 42.

Here, “substantially orthogonal” represents that it is not necessary to be completely orthogonal and a slightly inclined may exist.

According to this embodiment, since leakage of light from the surface other than the incident surface 42 (emission surface) can be prevented, the light extraction efficiency from the incident surface 42 (emission surface) side is higher, and the luminance can be further raised.

### Third Embodiment

A transparent phosphor 4 according to this embodiment is similar to the transparent phosphor 4 of the second embodiment except for the following configuration.

The transparent phosphor 4 according to this embodiment includes an excitation light control film 10 on the incident surface 42. The excitation light control film 10 allows incident blue light LB (incident excitation light) to be transmitted therethrough, and reflects again the blue light LB (reflected excitation light) reflected from the transparent phosphor 4. That is, in this embodiment, the blue light LB is caused to propagate in one way by the excitation light control film 10.

In this embodiment, reflection of the blue light LB from the incident surface 42 (emission surface) of the transparent phosphor 4 can be prevented due to the excitation light control film 10, and illumination with high stability is realized. In addition, since the blue light LB can be allowed to remain inside the transparent phosphor 4 until the blue light LB can be sufficiently converted, conversion efficiency to the fluorescence LF can be raised.

Note that, since the blue light LB is scatted by the excitation light control film 10, the white light LW is composed by the scattered blue light LB and the fluorescence LF after wavelength conversion.

The thickness of the excitation light control film 10 according to this embodiment is not particularly limited, but the thickness is preferably 0.3 μm or greater, and more preferably 0.4 to 0.8 μm. When the thickness of the excitation light control film 10 is within the above-described range, incident blue light LB is likely to be transmitted, and the blue light LB reflected from the transparent phosphor 4 is likely to be reflected again.

The component of the excitation light control film 10 according to this embodiment is not particularly limited, but the component includes an oxide or a fluoride of at least one kind selected from the group consisting of Al, Ti, Hf, Si, Mg, Ca, La, Ce, Y, Zr, and Ta.

A method of forming the excitation light control film 10 is not particularly limited, but examples thereof include a vacuum deposition method, a sputtering method, a pulse laser deposition method (PLD method), a metal-organic chemical vapor deposition method (MO-CVD method), a metal-organic decomposition method (MOD method), a sol-gel method, a chemical solution deposition method (CSD method), and the like.

The present invention is not limited to the above-described embodiments, and various modifications can be made within the range of the present invention.

For example, in the first embodiment, the transparent phosphor 4 includes the reflective film 8 on the reflective surface 46, but the transparent phosphor 4 may not include the reflective film 8 on the reflective surface 46.

In addition, in the first embodiment, the reflective film 8 is directly formed on the reflective surface 46, but the reflective film 8 may be formed on the reflective surface 46 through a bonding layer. The joining layer is easy to be bonded to any one of the reflective surface 46 and the reflective film 8. Accordingly, when the reflective film 8 is formed on the reflective surface 46 through the bonding layer, integration between the transparent phosphor 4 and the reflective film 8 can be raised.

### EXAMPLES

Hereinafter, the present invention will be described in more detail with reference to examples, but the present invention is not limited to the examples.

### Experiment 1

In Sample Number 1 to sample Number 17, disc-shaped transparent phosphor 4 having a diameter of 10 mm were prepared. Note that, a thickness, a composition, a crystal state, and a transmittance at 540 nm are as shown in Table 1 and Table 2. The transmittance at 540 nm was measured by using a spectrophotometer (manufactured by SHIMADZU, model number: UV-2550).

One disc-shaped surface of the transparent fluorescent bodies was polished by using a polishing cloth with an abrasive grain number described in Table 1, and was set as an incident surface. In addition, the other disc-shaped surface of the transparent phosphor was polished by using a polishing cloth with an abrasive grain number #4000, and was set as a reflective surface. Note that, the abrasive grain number conforms to JIS R 6001.

With respect to the obtained transparent fluorescent bodies, arithmetic average roughness (IRa) of the incident surface and arithmetic average roughness (RRa) of the reflective surface were measured in conformity to “arithmetic average roughness” in JIS B 0601. Note that, a reference length of the arithmetic average roughness was set to 2 mm. Results are shown in Table 1 and Table 2.

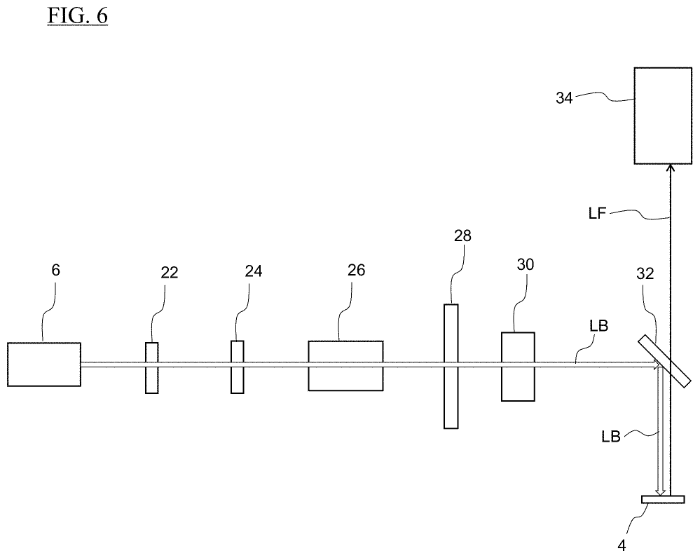

The obtained transparent phosphor 4 was irradiated with blue laser light LB by using a device illustrated in FIG. 6. Specifically, the blue laser light LB that is emitted from the blue laser light source 6 and has an elliptical cross-section was converted into light beams having a circular cross-section by an anamorphic prism pair 22.

Then, the blue laser light LB was transmitted through an isolator 24. In the isolator 24, light travelling in a forward direction was transmitted, and light travelling in an opposite direction was blocked.

Then, the blue laser light LB was caused to be transmitted through a beam expander 26 to enlarge a cross-sectional area of the light.

Then, the blue laser light LB was caused to be transmitted through an ND filter 28 to attenuate light.

Then, the blue laser light LB was caused to be transmitted through a λ/2 plate 30 to rotate incident linearly polarized light.

Then, the blue laser light LB was reflected by a dichroic block 32, and the blue laser light LB having a diameter b of 300 μm and a wavelength of 480 nm was incident to the transparent phosphor 4. The blue laser light LB incident to the transparent phosphor 4 was converted into fluorescence LF and was reflected toward the dichroic block 32. The dichroic block 32 allows only the fluorescence LF to be transmitted therethrough and does not allow the blue laser light LB to be transmitted therethrough, and thus only the fluorescence LF can be photographed by a CCD camera 34.

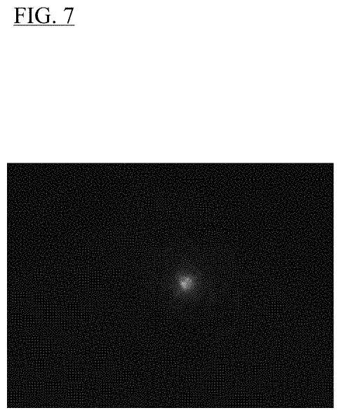

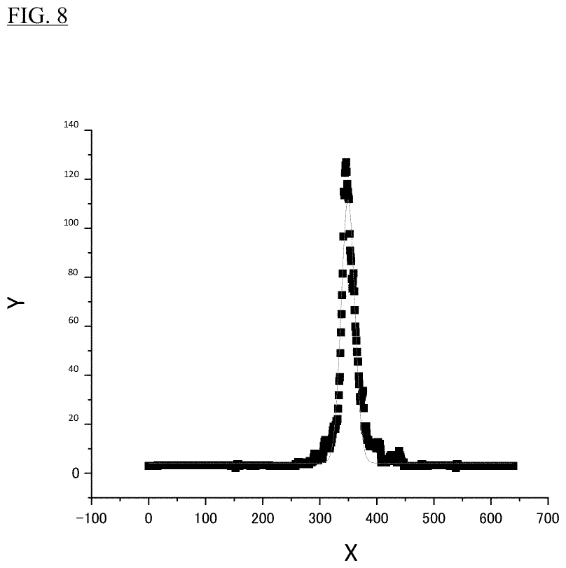

A photograph of the fluorescence LF received by the CCD camera 34 with regard to Sample Number 2 is shown in FIG. 7. Furthermore, with regard to FIG. 7, a graph illustrated in FIG. 8 was created. FIG. 8 illustrates relative luminance at respective positions on a line segment passing through approximately the central portion of light-emitting spot diameter illustrated in FIG. 7. Specifically, a length [mm] from a starting point on the line segment to respective measurement points is shown in the horizontal axis (X) and relative luminance in the respective measurement points is shown in the vertical axis (Y). Note that, “relative luminance” represents relative luminance when peak luminance in Example 7 is set to 100.

A full width at half maximum in the graph in FIG. 8 was set as a full width at half maximum (spot FWHM) of the light-emitting spot diameter. In addition, a peak of luminance in the graph in FIG. 8 was set as relative peak luminance. The spot FWHM and the relative peak luminance in respective samples of Sample Number 1 to Sample Number 17 were obtained in a similar manner. Results are shown in Table 1 and Table 2.

TABLE 1

| | | | | | Arithmetic | Arithmetic | |
|---|---|---|---|---|---|---|---|
| | | | | | average | average | |
| | | | | | roughness | roughness | |
| | | | | | of incident | of reflective | |
| | | | Sample | 540 nm | surface | surface | Spot |
| Sample | Material | | thickness | transmittance | (IRa) | (RRa) | FWHM |
| number | Composition | Crystal state | [mm] | [%] | [μm] | [μm] | [μm] |
| 1 | (Ce_{0.007}, Y_{0.995})₃Al₅O₁₂ | Single crystal | 0.5 | 78 | 2.35 | 0.25 | 34.77 |
| 2 | (Ce_{0.007}, Y_{0.995})₃Al₅O₁₂ | Single crystal | 0.5 | 78 | 1.49 | 0.26 | 27.85 |
| 3 | (Ce_{0.007}, Y_{0.995})₃Al₅O₁₂ | Single crystal | 0.5 | 78 | 0.90 | 0.25 | 26.07 |
| 4 | (Ce_{0.007}, Y_{0.995})₃Al₅O₁₂ | Single crystal | 0.5 | 78 | 0.86 | 0.25 | 38.55 |
| 5 | (Ce_{0.007}, Y_{0.995})₃Al₅O₁₂ | Polycrystal | 0.5 | 73 | 0.87 | 0.25 | 38.76 |
| 6 | (Ce_{0.007}, Y_{0.995})₃Al₅O₁₂ | Single crystal | 0.5 | 78 | 0.80 | 0.26 | 38.89 |
| 7 | (Ce_{0.007}, Y_{0.995})₃Al₅O₁₂ | Single crystal | 0.5 | 78 | 0.72 | 0.26 | 39.39 |
| 8 | (Ce_{0.007}, Y_{0.995})₃Al₅O₁₂ | Single crystal | 0.5 | 78 | 0.25 | 0.26 | 47.00 |
| 9 | (Ce_{0.007}, Y_{0.995})₃Al₅O₁₂ | Polycrystal | 0.5 | 73 | 0.24 | 0.24 | 49.52 |
| 10 | (Ce_{0.007}, Y_{0.995})₃Al₅O₁₂ | Single crystal | 0.5 | 78 | 0.72 | 0.30 | 41.09 |

| | Excitation light control film | | Reflective film | | | | Abrasive | Relative |
|---|---|---|---|---|---|---|---|---|
| | Incident surface | | Reflective surface | | Side surface | | grain | peak |
| Sample | | Thickness | | Thickness | | Thickness | number | luminance |
| number | Component | [μm] | Component | [μm] | Component | [μm] | (#) | [—] |
| 1 | None | 0 | None | 0 | None | 0 | 50 | 102 |
| 2 | None | 0 | None | 0 | None | 0 | 100 | 108 |
| 3 | None | 0 | None | 0 | None | 0 | 600 | 110 |
| 4 | None | 0 | None | 0 | None | 0 | 800 | 104 |
| 5 | None | 0 | None | 0 | None | 0 | 800 | 100 |
| 6 | None | 0 | None | 0 | None | 0 | 1000 | 101 |
| 7 | None | 0 | None | 0 | None | 0 | 1200 | 100 |
| 8 | None | 0 | None | 0 | None | 0 | 4000 | 92 |
| 9 | None | 0 | None | 0 | None | 0 | 4000 | 88 |
| 10 | None | 0 | None | 0 | None | 0 | 1200 | 100 |

TABLE 2

| | | | | | Arithmetic | Arithmetic | |
|---|---|---|---|---|---|---|---|
| | | | | | average | average | |
| | | | | | roughness | roughness | |
| | | | | | of incident | of reflective | |
| | | | Sample | 540 nm | surface | surface | Spot |
| Sample | Material | | thickness | transmittance | (IRa) | (RRa) | FWHM |
| number | Composition | Crystal state | [mm] | [%] | [μm] | [μm] | [μm] |
| 11 | (Ce_{0.007}, Y_{0.995})₃Al₅O₁₂ | Single crystal | 0.3 | 78 | 2.31 | 0.26 | 29.54 |
| 12 | (Ce_{0.007}, Y_{0.995})₃Al₅O₁₂ | Single crystal | 0.3 | 78 | 1.55 | 0.25 | 22.17 |
| 13 | (Ce_{0.007}, Y_{0.995})₃Al₅O₁₂ | Single crystal | 0.3 | 78 | 0.93 | 0.26 | 22.04 |
| 14 | (Ce_{0.007}, Y_{0.995})₃Al₅O₁₂ | Single crystal | 0.3 | 78 | 0.84 | 0.26 | 31.43 |
| 15 | (Ce_{0.007}, Y_{0.995})₃Al₅O₁₂ | Single crystal | 0.3 | 78 | 0.81 | 0.26 | 32.75 |
| 16 | (Ce_{0.007}, Y_{0.995})₃Al₅O₁₂ | Single crystal | 0.3 | 78 | 0.76 | 0.25 | 33.99 |
| 17 | (Ce_{0.007}, Y_{0.995})₃Al₅O₁₂ | Single crystal | 0.3 | 78 | 0.26 | 0.26 | 35.26 |

| | Excitation light control film | | Reflective film | | | | Abrasive | Relative |
|---|---|---|---|---|---|---|---|---|
| | Incident surface | | Reflective surface | | Side surface | | grain | peak |
| Sample | | Thickness | | Thickness | | Thickness | number | luminance |
| number | Component | [μm] | Component | [μm] | Component | [μm] | (#) | [—] |
| 11 | None | 0 | None | 0 | None | 0 | 50 | 119 |
| 12 | None | 0 | None | 0 | None | 0 | 100 | 121 |
| 13 | None | 0 | None | 0 | None | 0 | 600 | 123 |
| 14 | None | 0 | None | 0 | None | 0 | 800 | 116 |
| 15 | None | 0 | None | 0 | None | 0 | 1000 | 113 |
| 16 | None | 0 | None | 0 | None | 0 | 1200 | 110 |
| 17 | None | 0 | None | 0 | None | 0 | 4000 | 94 |

From Table 1, it could be confirmed that in a case where the arithmetic average roughness (IRa) of the incident surface is larger than the arithmetic average roughness (RRa) of the reflective surface (Sample Number 1 to Sample Number 7, and Sample Number 10), the full width at half maximum (spot FWHM) of the light-emitting spot is smaller, the light-emitting spot diameter can be further narrowed, and the relative peak luminance is higher in comparison to a case where the arithmetic average roughness (IRa) of the incident surface is the same as the arithmetic average roughness (RRa) of the reflective surface (Sample Number 9) or a case where the arithmetic average roughness (IRa) of the incident surface is smaller than the arithmetic average roughness (RRa) of the reflective surface (Sample Number 8).

In addition, from Table 2, even in the sample thickness was 0.3 mm, it could be confirmed that in a case where the arithmetic average roughness (IRa) of the incident surface is larger than the arithmetic average roughness (RRa) of the reflective surface (Sample Number 11 to Sample Number 16), the full width at half maximum (spot FWHM) of the light-emitting spot diameter is smaller, the light-emitting spot diameter can be further narrowed, and the relative peak luminance is higher in comparison to a case where the arithmetic average roughness (IRa) of the incident surface is the same as the arithmetic average roughness (RRa) of the reflective surface (Sample Number 17).

### Experiment 2

Transparent fluorescent bodies were obtained in a similar manner as in Experiment 1 except that a reflective film was formed on the reflective surface in Sample Number 18 and Sample Number 20, and the reflective film was formed on the reflective surface and the side surface in Sample Number 19 and Sample Number 21. The arithmetic average roughness (IRa) of the incident surface, the arithmetic average roughness (RRa) of the reflective surface, the full width at half maximum (spot FWHM) of the light-emitting spot diameter, and the relative peak luminance were measured. Results are shown in Table 3. Note that, the component and the thickness of the reflective film were as shown in Table 3. In addition, the reflective film was formed by a vacuum vapor deposition.

TABLE 3

| | | | | | Arithmetic | Arithmetic | |
|---|---|---|---|---|---|---|---|
| | | | | | average | average | |
| | | | | | roughness | roughness | |
| | | | | | of incident | of reflective | |
| | | | Sample | 540 nm | surface | surface | Spot |
| Sample | Material | | thickness | transmittance | (IRa) | (RRa) | FWHM |
| number | Composition | Crystal state | [mm] | [%] | [μm] | [μm] | [μm] |
| 18 | (Ce_{0.007}, Y_{0.995})₃Al₅O₁₂ | Single crystal | 0.5 | 78 | 0.90 | 0.25 | 26.07 |
| 19 | (Ce_{0.007}, Y_{0.995})₃Al₅O₁₂ | Single crystal | 0.5 | 78 | 0.90 | 0.25 | 26.07 |
| 20 | (Ce_{0.007}, Y_{0.995})₃Al₅O₁₂ | Single crystal | 0.5 | 78 | 0.90 | 0.25 | 26.07 |
| 21 | (Ce_{0.007}, Y_{0.995})₃Al₅O₁₂ | Single crystal | 0.5 | 78 | 0.90 | 0.25 | 26.07 |

| | Excitation light control film | | Reflective film | | | | Abrasive | Relative |
|---|---|---|---|---|---|---|---|---|
| | Incident surface | | Reflective surface | | Side surface | | grain | peak |
| Sample | | Thickness | | Thickness | | Thickness | number | luminance |
| number | Component | [μm] | Component | [μm] | Component | [μm] | (#) | [—] |
| 18 | None | 0.00 | SiO₂ | 3.00 | None | 0.00 | 800 | 133 |
| 19 | None | 0.00 | SiO₂ | 3.10 | SiO₂ | 3.30 | 800 | 142 |
| 20 | None | 0.00 | SiO₂ | 2.10 | None | 0.00 | 800 | 118 |
| 21 | None | 0.00 | SiO₂ | 2.10 | SiO₂ | 1.80 | 800 | 125 |

From Table 3, it could be confirmed that in a case where the reflective film is provided on the reflective surface (Sample Number 18 to Sample Number 21), the relative peak luminance becomes higher. In addition, from Table 3, it could be confirmed that in a case where the reflective film is provided on the side surface (Sample Number 19 and Sample Number 21), the relative peak luminance becomes further higher.

### Experiment 3

In Sample Number 22 and Sample Number 23, transparent fluorescent bodies were obtained in a similar manner as in Experiment 1 except that an excitation light control film was formed on the incident surface, and the arithmetic average roughness (IRa) of the incident surface, the arithmetic average roughness (RRa) of the reflective surface, the full width at half maximum (spot FWHM) of the light-emitting spot diameter, and the relative peak luminance were measured. Results are shown in Table 4. Note that, the component and the thickness of the excitation light control film were as shown in Table 4. In addition, the excitation light control film was formed by a vacuum vapor deposition.

TABLE 4

| | | | | | Arithmetic | Arithmetic | |
|---|---|---|---|---|---|---|---|
| | | | | | average | average | |
| | | | | | roughness | roughness | |
| | | | | | of incident | of reflective | |
| | | | Sample | 540 nm | surface | surface | Spot |
| Sample | Material | | thickness | transmittance | (IRa) | (RRa) | FWHM |
| number | Composition | Crystal state | [mm] | [%] | [μm] | [μm] | [μm] |
| 22 | (Ce_{0.007}, Y_{0.995})₃Al₅O₁₂ | Single crystal | 0.5 | 78 | 0.90 | 0.25 | 26.07 |
| 23 | (Ce_{0.007}, Y_{0.995})₃Al₅O₁₂ | Single crystal | 0.5 | 78 | 0.90 | 0.25 | 26.07 |

| | Excitation light control film | | Reflective film | | | | Abrasive | Relative |
|---|---|---|---|---|---|---|---|---|
| | Incident surface | | Reflective surface | | Side surface | | grain | peak |
| Sample | | Thickness | | Thickness | | Thickness | number | luminance |
| number | Component | [μm] | Component | [μm] | Component | [μm] | (#) | [—] |
| 22 | SiO₂ | 0.33 | None | 0.00 | None | 0.00 | 800 | 124 |
| 23 | SiO₂ | 0.24 | None | 0.00 | None | 0.00 | 800 | 115 |

From Table 4, it could be confirmed that in a case where the excitation light control film is provided on the incident surface (Sample Number 22 and Sample Number 23), the relative peak luminance becomes further higher.

### EXPLANATIONS OF LETTERS OR NUMERALS

2 LIGHT SOURCE DEVICE
4 TRANSPARENT PHOSPHOR
40 IRRADIATION POSITION
42 INCIDENT SURFACE
46 REFLECTIVE SURFACE
48 SIDE SURFACE
6 BLUE LIGHT-EMITTING ELEMENT, BLUE LASER LIGHT SOURCE
8 REFLECTIVE FILM
10 EXCITATION LIGHT CONTROL FILM
22 ANAMORPHIC PRISM PAIR
24 ISOLATOR
26 BEAM EXPANDER
28 ND FILTER
30 λ/2 PLATE
32 DICHROIC BLOCK
34 CCD CAMERA
LB BLUE LIGHT, BLUE LASER LIGHT
LF FLUORESCENCE
LW WHITE LIGHT

1. A transparent phosphor comprising a pair of surfaces,
wherein one surface is rougher than the other surface.

2. The transparent phosphor according to claim 1,
wherein the pair of surfaces face each other.

3. The transparent phosphor according to claim 1,
wherein arithmetic average roughness (IRa) of the one surface is 0.80 m or greater.

4. The transparent phosphor according to claim 1,
wherein arithmetic average roughness (RRa) of the other surface is 0.30 m or less.

5. The transparent phosphor according to claim 1,
wherein a transmittance of light having a wavelength of 540 nm is 70% or greater.

6. The transparent phosphor according to claim 1,
in which a composition of a main component of the transparent phospher is AₓB_{y}O_{z},
x is 2.7 to 3.3,
y is 4.7 to 5.3,
z is 11.7 to 12.3,
A is at least one kind selected from the group consisting of Y, Gd, Tb, Yb, and Lu,
B is at least one kind selected from the group consisting of Al, Ga, and Sc, and
an activating agent is at least one kind selected from the group consisting of lanthanoid elements and actinide elements.

7. The transparent phosphor according to claim 6,
wherein A comprises Y, and B comprises Al,
the activating agent is at least one kind selected from the group consisting of Ce, Nd, and Gd, and
the amount of the activating agent is 0.7 to 2.5 parts by mol, when the amount of Y is set as 100 parts by mol.

8. The transparent phosphor according to claim 1,
wherein the one surface is an incident surface of excitation light, and the other surface is a reflective surface of the excitation light.

9. The transparent phosphor according to claim 8,
wherein the incident surface is also an emission surface of the excitation light.

10. The transparent phosphor according to claim 8,
wherein the transparent phosphor includes a reflective film on the reflective surface.

11. The transparent phosphor according to claim 8,
wherein a reflective film is provided on a surface other than the incident surface.

12. The transparent phosphor according to claim 10,
wherein the thickness of the reflective film is 3 m or greater, and
the reflective film contains an oxide of at least one kind selected from the group consisting of Si, Ti, and Al.

13. The transparent phosphor according to claim 8,
wherein the transparent phosphor includes an excitation light control film on the incident surface,
the excitation light control film allows incident excitation light to be transmitted therethrough, and reflects again reflected excitation light transmitted from the transparent phosphor, and
the thickness of the excitation light control film is 0.3 μm or greater.

14. A light source device, comprising:
the transparent phosphor according to claim 1; and
a blue light-emitting element,
wherein the blue light-emitting element is at least one selected from a blue light-emitting diode and a blue semiconductor laser.
